(19) United States
(12) Patent Application Publication
(10) Pub. No.: US 2026/0278995 A1
(43) Pub. Date: Sep. 17, 2026

(54) Automated Roof Plan Extraction and Dimensioning Using Artificial Intelligence

(71) Applicant: Areg Aghayants, Burbank, CA (US)

(72) Inventor: Areg Aghayants, Burbank, CA (US)

(21) Appl. No.: 19/077,643

(22) Filed: Mar. 12, 2025

(51) Int. Cl. G06V 10/26; G06F 40/169; G06V 10/44; G06V 10/48; G06V 10/58; G06V 10/82; G06V 20/10; G06V 20/13

(52) U.S. Cl. CPC G06V 10/273; G06F 40/169; G06V 10/443; G06V 10/48; G06V 10/58; G06V 10/82; G06V 20/13; G06V 20/176

(57) ABSTRACT

A method and system are provided for automated extraction of roof plans, determination of roof dimensions, and generation of solar panel layouts. One implementation processes roof images by detecting line segments using techniques such as LSD or the Hough Transform, and constructing a graph with vertices formed by these segments connected by distance-weighted edges. Refinement steps include filtering out non-structural lines, merging segments, thresholding, and removing redundancies to produce an accurate roof plan. A pre-trained AI segmentation model—with a potential multi-task architecture for predicting lines, points, and segmentation fields—is used to recognize roof contours and obstacles, including oriented objects, with an iterative process ensuring candidate lines correspond to roof vertices.

### BACKGROUND OF THE INVENTION

Modern building design and energy integration efforts increasingly rely on the precise mapping and analysis of architectural features, particularly when incorporating renewable energy elements into existing structures. Traditional measurement techniques often require physical access to rooftops, which introduces risks such as falls, structural damage, or exposure to hazardous environments. Photogrammetry—the science of extracting measurements from images—eliminates these dangers by allowing professionals to assess roof characteristics remotely. High-resolution photos captured via drones, satellites, or ground-based cameras are processed through specialized software (e.g., Pix4D, HOVER) to generate scaled 3D models. However, the manual extraction and interpretation of roof plans—a process that can be time-consuming and prone to human error.

Accurately determining roof dimensions has become an indispensable practice across industries ranging from construction and architecture to telecommunications and insurance. For instance, in roofing projects, even minor errors in dimension calculations can lead to significant material waste or shortages. A 2% error in measuring a 2,000-square-foot roof could result in 40 square feet of excess or insufficient shingles, directly impacting project costs and timelines. Solar installers need accurate roof plan determination to provide quotes for projects. Similarly, telecommunications companies rely on accurate roof dimensions to install antennas or satellite dishes with optimal line-of-sight alignment, avoiding obstructions like trees or neighboring buildings that could degrade signal quality.

### SUMMARY OF THE INVENTION

In one aspect, a method determines a roof plan from a document by detecting line segments in the image using a line detection technique and constructs a graph using AI where each detected line segment is a vertex, with edges defined by the distance measured between segments, such that the largest connected component of the graph represents the roof plan. In one implementation, the method extracts a roof layout from the roof plan by filtering out lines that do not correspond to roof structural elements.

In another aspect, a computer-implemented method is provided for determining roof dimensions and pitch. The method receives multiple labeled rooftop image datasets that include photographs, aerial imagery, or satellite imagery along with annotated geometric measurements of roof edges, slopes, and obstructions. It trains an AI model through supervised machine learning to correlate pixel patterns with the annotated measurements, optimizing a loss function that evaluates the accuracy of predicted roof edges, facet lengths, and slope angles. The method then processes an unlabeled rooftop image through the trained AI model to detect perimeter boundaries, segment distinct roof facets, and calculate planar angles between adjacent facets. Finally, a dimensioned roof diagram is generated that specifies measurements for each facet edge and angular measurements for intersecting planes.

In yet another aspect, a computer-implemented method retrieves satellite imagery of a target geographic location through an API provided by a satellite image service. In yet another aspect, a multi-task convolutional neural network processes the satellite imagery to detect roof structural elements by extracting line segments using multi-scale Line Segment Detection, identifying roof vertices via regression of intersections, and constructing a weighted graph of roof topology with vertices and edges weighted by Euclidean distances. In yet another aspect, obstacle detection is executed through a deep learning model that predicts oriented bounding boxes by processing both black-and-white and color-enhanced versions of architectural PDFs, then matching coordinates between PDF-derived obstacles and satellite imagery using scale normalization and the intersection over union (IoU) calculations. In yet another aspect, solar panel layout parameters are generated through constrained optimization that accounts for azimuth-adjusted panel orientation relative to roof slopes, minimum inter-panel spacing that meets fire safety regulations, and shading projections based on historical sun path trajectories. In yet another aspect, a digital installation blueprint is output with specified panel coordinates, tilt angles, and interconnection pathways.

Advantages of one implementation may include one or more of the following:
Enhanced accuracy and precision in identifying and extracting roof plans from a variety of input documents, thereby reducing reliance on manual interpretation and minimizing human error.
Increased automation in processing architectural images through graph-based algorithms and AI techniques, which enables more efficient mapping of roof features even in complex layouts.
Rapid generation of detailed, dimensioned roof diagrams that integrate linear measurements and angular relationships, streamlining the design workflow for solar panel installations and other rooftop applications.
Improved scalability and adaptability by utilizing supervised learning and multi-task convolutional neural networks that can be trained on diverse rooftop datasets, including aerial, satellite, and architectural PDF imagery.
Robust obstacle and structural element detection, achieved through a combination of advanced line segment detection, heatmap regression, and weighted graph construction methods that ensure a high level of precision even in cluttered or low-quality images.
Integration of satellite imagery retrieval via API, which provides real-time geographic data and further refines the analysis of roofing elements, potentially enhancing the accuracy of solar panel layout planning with respect to local environmental factors.
Optimized solar panel layout planning that incorporates regulatory safety requirements (such as minimum inter-panel spacing), azimuth-adjusted panel orientation relative to roof slopes, and shading projections based on historical sun trajectories, ensuring efficiency and compliance.
The overall reduction in planning time and costs associated with rooftop renovations or new installations, as the automated methods significantly decrease the need for extensive manual measurements and corrections.

By combining these advantages, one implementation provides a comprehensive digital solution that enhances both the design and implementation processes in renewable energy integration and modern construction practices.

### BRIEF DESCRIPTION OF DRAWINGS

FIG. 1 shows flowchart depicting steps for automated roof plan extraction and layout generation using AI.

FIG. 2 shows flowchart illustrating a method for extracting and matching roof layouts with satellite images using AI models.

FIG. 3 shows flowchart depicting an automated process for roof plan extraction and dimensioning using AI.

FIG. 4 shows flowchart depicting the analysis of roof regions and facet areas by an AI model.

FIG. 5 shows flowchart detailing steps for optimizing solar panel layout, including sun path calculation, shading simulation, and PV module positioning.

FIG. 6a-6B shows flowchart depicting the process of automated roof plan extraction, dimensioning, and solar panel layout generation using artificial intelligence.

FIG. 7 shows flowchart illustrating steps for automated roof plan processing and extraction.

FIG. 8 shows flowchart showing a method for real-time validation, solar irradiation simulation, warranty compliance checking, and automated redesign triggering.

FIG. 9 shows flowchart detailing a method for processing a weighted graph representation in roof plan extraction.

FIG. 10 shows flowchart for solar panel layout parameters incorporating tilt angles, inverter capacity, and maintenance pathways.

FIG. 11A-11B and 12A-12D show exemplary AI based roof plan determinations.

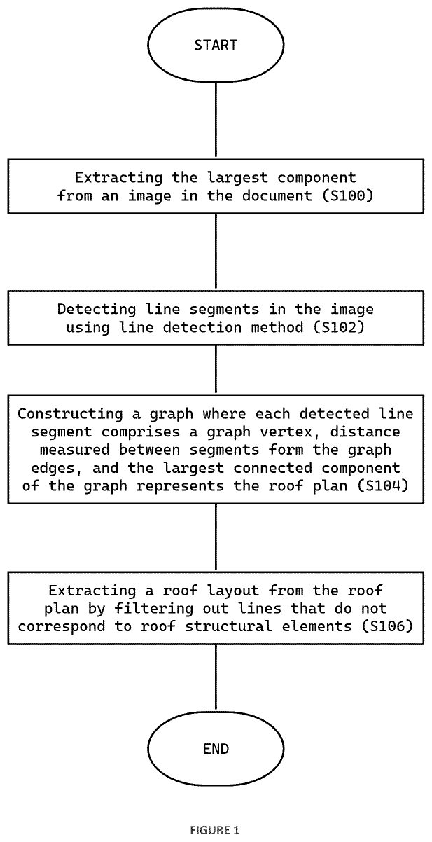

### DETAILED DESCRIPTION OF THE INVENTION

An automated, AI-driven system is disclosed to accurately generate roof layouts from architectural plans, photos, aerial and satellite imagery. The system is ideal for applications such as solar panel installations and roof repair assessments. Initially, the system ingests PDF documents containing architectural roof plans without any human intervention in the data preparation process. This automated data ingestion workflow begins by extracting the largest component of each PDF page, typically corresponding to the primary roof plan area. The term “largest component” refers to the continuous surface area bounded by primary structural members indicative of a roof.

The extraction leverages classical line detection algorithms, including Line Segment Detector (LSD) and Hough Transform methods, to identify line segments representing structural elements of the roof. These detected line segments undergo merging and thresholding operations to eliminate redundant or overlapping lines, ensuring a clean representation of structural elements. Importantly, this process is performed on both black-and-white and colored versions of the PDF documents, as roof plans may include annotations or overlays that necessitate dual processing modes for optimal accuracy. After initial line detection, the system applies further filtering steps to remove extraneous lines that do not correspond to structural roof elements, thereby refining the extracted layout into a precise representation suitable for subsequent computational analysis.

Following line detection and filtering, the system constructs a graph-based representation of the roof layout wherein each detected line segment is treated as a vertex within a graph structure. Edges between these vertices are determined by calculating distance metrics between the detected segments. The largest connected component of this graph is then identified as representing the actual roof layout. Concurrently, obstacle detection within these PDFs is executed through a deep learning model specifically trained to identify oriented objects such as chimneys, vents, pipes, air conditioning units, and other rooftop obstructions. This obstacle detection model is integrated into the workflow to ensure comprehensive and accurate representation of all relevant rooftop features.

Next, to establish correspondence between extracted architectural plans and real-world satellite imagery, the system employs advanced language models capable of extracting textual information from PDFs, specifically targeting address details and scale indicators embedded within these documents. Once this textual metadata is extracted automatically via large language models and text processing techniques, corresponding satellite images are retrieved based on this extracted address information and scale parameters. To ensure accurate matching between architectural plans and satellite imagery, a large vision model—specifically a Segment Anything Model (SAM)—is employed to identify candidate buildings within satellite images. This identification process involves computing an Intersection over Union (IoU) metric between candidate building outlines proposed by the vision model and the extracted PDF-based roof layouts. If this computed IoU exceeds a predetermined threshold value indicating sufficient overlap between predicted satellite-derived building footprints and PDF-extracted layouts, these matched layouts are automatically added to an expanding ground truth dataset utilized for subsequent AI model training.

Intersection over Union (IoU) serves as a critical metric for evaluating spatial alignment accuracy in computer vision and structural documentation systems. IoU quantifies the overlap between two regions using the ratio: IoU=Area of Intersection/Area of Union. This produces values between 0 (no overlap) and 1 (perfect alignment).

Once this ground truth dataset has been established through successful IoU-based matches between PDF-derived layouts and satellite images, it serves as input for training a specialized segmentation model designed explicitly to predict accurate roof layouts directly from satellite imagery alone. Recognizing limitations in available training data volume, the segmentation model is intentionally designed as a lightweight convolutional encoder-decoder architecture optimized for efficiency with relatively few parameters. This lightweight approach enhances computational efficiency while maintaining robust predictive capabilities through multi-task learning strategies. Specifically configured as a multi-task neural network architecture, this model simultaneously predicts multiple complementary outputs: lines representing roof contours; points indicating vertices; and segmentation fields delineating complete roof areas. Such multi-task training leverages inherent complementarities among these tasks—line detection provides structural boundaries; point prediction identifies critical vertices; segmentation fields offer holistic spatial context—to yield improved overall accuracy despite limited training datasets.

To further enhance performance prior to deployment on proprietary datasets derived from PDFs and satellites images described above, this multi-task segmentation network undergoes pre-training using datasets focused on satellite-based roof contour mapping tasks. This pre-training step significantly boosts initial model accuracy by enabling transfer learning from relevant but broader public datasets into domain-specific applications involving detailed architectural plan interpretation paired with satellite imagery analysis.

Following successful training iterations on proprietary datasets created through automated processes described earlier—with no human intervention—the system transitions into inference mode packaged efficiently within Docker containers optimized for deployment onto hardware featuring NVIDIA GPUs with at least 8 GB VRAM alongside CPUs having four or more cores and minimum 16 GB RAM capacity. Inference execution involves feeding new satellite images into trained AI models that predict vertices (points), edges (lines), and segmentation fields (roof areas). Post-processing mechanisms subsequently verify predicted layout accuracy by ensuring candidate lines correspond precisely with predicted vertices—only those lines matching verified vertices are retained in final outputs. This verification step ensures reliability by enforcing strict geometric consistency criteria between predicted vertices and associated line segments.

In one system, the following is performed: Given an input coordinate or address, the system retrieves the corresponding satellite image from a satellite image provider, ensuring the building of interest is included. The AI model processes the image to infer the roof plan of the identified building. Using the extracted roof plan, the system generates an optimal solar panel layout

For training, the primary data source consists of documents such as images or PDFs containing architectural roof plans. These are processed to create accurate ground truth datasets for AI model training, including: Roof plan representation as a graph, Obstacle detection as oriented objects. During the data processing, the software:
a. Extracts the largest component of the page containing the roof plan.
b. Detects line segments using classical line detection methods (e.g., LSD, Hough Transform).
c. Merges detected lines, apply thresholding, and remove redundancies.
d. Repeats the process for both black-and-white and colored versions of the document, as roof plans are typically black and white but may be overlaid with annotations.
e. Extracts the final roof layout by filtering out lines that do not correspond to the structural elements of the roof.
f. Constructs a graph where: each detected line segment is a graph vertex and the distance measures between segments form the graph edges. The largest connected component of the graph represents the roof plan.
g. For obstacle detection, a deep learning model is trained to recognize obstacles within the document.

Satellite Image Matching is detailed next. To match the extracted roof layout with its corresponding satellite image:
a. The address and scale are extracted from the PDF using large language models and text processing techniques.
b. A satellite image is retrieved, and a large vision model (SAM) identifies candidate buildings.
c. The intersection over union (IoU) of the proposed building from the model and the layout from the PDF is computed.
d. If the IoU exceeds a threshold, the layout is added to the ground truth dataset.
e. A segmentation model is trained on the dataset obtained in step c to predict the roof. Step 3 is repeated by incorporating predictions from step d.

In one implementation, a convolutional encoder-decoder architecture trained as a multi-task model, predicting: Lines (roof contours), Points (vertices), and Segmentation fields (roof). By designing the model as a multi-task network, a simple yet robust architecture is used that benefits from the complementary nature of these tasks. The models are pre-trained on a dataset related to satellite-based roof contour mapping, significantly improving performance.

Inferencing Mechanisms are detailed next. After predicting roof layout vertices and edges, post-processing is performed based on the principle that a candidate line is part of the roof layout only if it can be matched with a corresponding roof vertex. The verification process ensures the final layout is accurate and reliable.

The system is designed to efficiently utilize available hardware resources, including GPU acceleration for deep learning inference and CPU parallel processing for supporting computations. Optimization techniques include:

Parallel processing for simultaneous image and data analysis.

Algorithmic complexity reduction to eliminate performance bottlenecks.

Hardware-specific optimizations to leverage NVIDIA CUDA for accelerating deep learning inference.

Another implementation includes a technique for extracting the largest component from an image in a document, as recited in reference label S100. In one aspect, an image is processed to perform connected component analysis wherein each contiguous region of pixels is identified and compared based on its size. The method selects the contiguous region having the largest area, thereby designating it as the primary subject of further processing. This step, identified as S100, ensures that the principal component—presumed to correspond to the core structure of interest—is isolated from extraneous details and image noise prior to additional analysis.

In one embodiment, the method includes detecting line segments in the image using a line detection method, as designated by reference sign S102. The process involves analyzing the image to identify and delineate continuous linear features, which represent inherent structural boundaries within the roof plan. In this implementation, image processing algorithms are applied to enhance edges and contrast before candidate segments are extracted. The detection step effectively differentiates significant line segments from background noise, thereby supporting subsequent operations that require precise geometric representations of the roof structure.

The method includes constructing a graph in which each detected line segment is treated as a vertex. Distances measured between the segments are used to establish the edges of the graph. By analyzing the connectivity within this graph, the largest connected component is identified and designated as the roof plan. This approach, as disclosed in reference label S104, efficiently organizes extracted line information into a coherent structure for further roof layout processing.

The method includes a step where a roof layout is obtained from a previously generated roof plan. In this step, the process systematically removes lines that do not correspond to roof structural elements. Filtering criteria are applied to the set of lines in the roof plan to differentiate those that represent genuine features of the roof structure—such as boundaries, ridge lines, and other key architectural components—from lines that are extraneous or produced as artifacts in the image. Only the lines that correspond to these structural components are retained, resulting in a refined roof layout that accurately delineates the physical structure of the roof.

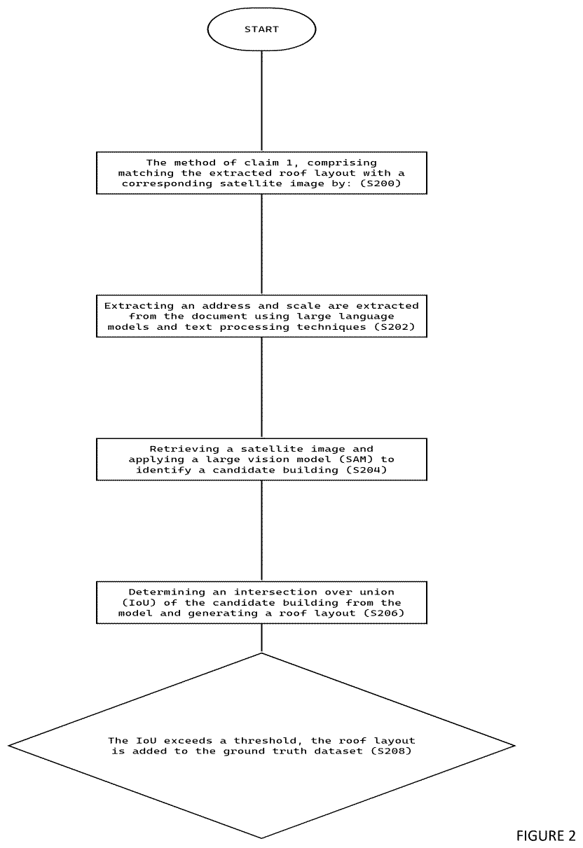

FIG. 2 illustrates the following references: a method for extracting and matching roof layouts with satellite images using AI models. The process involves extracting an address and scale from a document, retrieving a satellite image, and applying a vision model to identify candidate buildings. It then determines an intersection over union (IoU) to generate a roof layout, adding it to the dataset if it exceeds a threshold.

The process involves extracting an address and scale from the document using large language models along with text processing techniques. This step ensures precise alignment of the roof layout with corresponding satellite imagery.

The method involves retrieving a satellite image of the specified location through a satellite image provider API. The retrieved image is then processed using a large vision model, such as the Segment Anything Model (SAM), to identify potential candidate buildings within the imagery. This identification step facilitates further analysis and matching with extracted roof layouts.

In this stage, the method involves determining the intersection over union (IoU) for the candidate building as identified by the model. This calculation evaluates the overlap between the building's detected outline and the actual roof layout from satellite imagery. Once the IoU meets or exceeds a predefined threshold, the system generates a roof layout that is subsequently incorporated into further data processing.

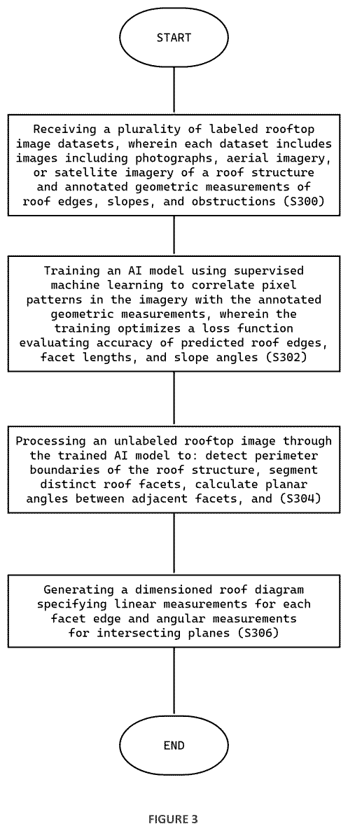

FIG. 3 illustrates a flowchart depicting an automated process for roof plan extraction and dimensioning using AI.

The process initiates with the acquisition of multiple labeled rooftop image datasets. Each dataset comprises images such as photographs, aerial imagery, or satellite imagery depicting roof structures. These images are accompanied by annotated geometric measurements that detail specific roof features, including edges, slopes, and obstructions. This foundational step is designated as S300 in the procedural flowchart.

The process begins with the training of an artificial intelligence model using supervised machine learning techniques. This involves correlating pixel patterns found in imagery datasets with annotated geometric measurements, such as roof edges, facet lengths, and slope angles. The training procedure is designed to optimize a loss function, which serves to assess the accuracy of these predicted measurements. This step ensures that the AI model accurately identifies and predicts various roof characteristics from the given images.

The process of generating a dimensioned roof diagram involves specifying linear measurements for each facet edge. This step also includes providing angular measurements for planes where roof facets intersect. The aim is to create a comprehensive and accurate representation of the roof structure, highlighting both its geometric and spatial properties.

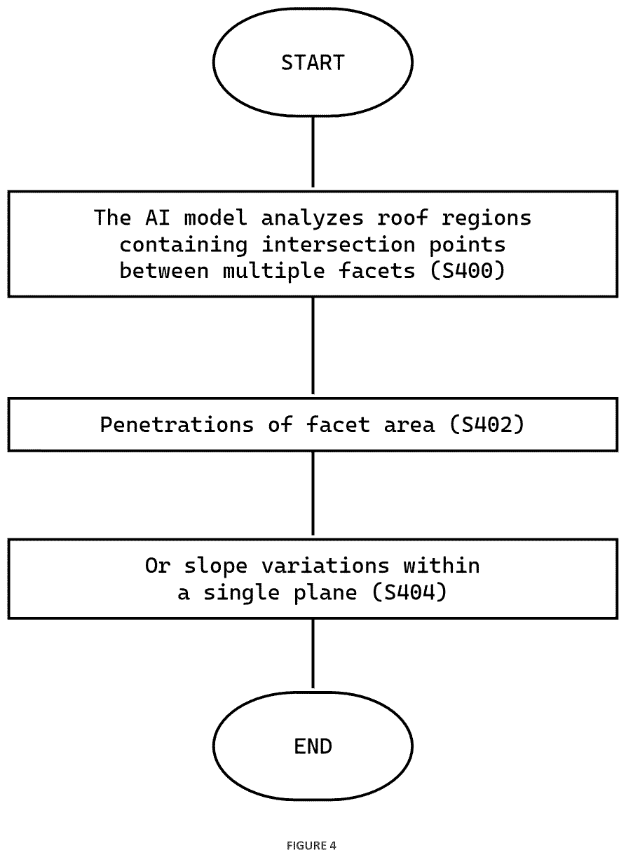

FIG. 4 illustrates the following references: The flowchart depicts the analysis process conducted by an AI model, which examines roof regions containing intersection points between multiple facets (S400), considers penetrations of facet areas (S402), and evaluates slope variations within a single plane (S404).

Referring to step S402, the method analyzes the penetrations within the facet areas of a roof structure. The process examines interruptions or discontinuities present within individual roof facets, including features like chimneys, vents, or skylights. This analysis is essential for accurately modeling the roof layout as it ensures that these penetrations are accounted for, influencing the positioning and installation of other components such as solar panels.

The reference label “slope variations within a single plane S404” refers to the capability of an AI model to analyze and identify differences in slope within a singular planar section of a roof structure. This involves determining how the incline or gradient changes across the surface, which is essential for accurate roof modeling and analysis.

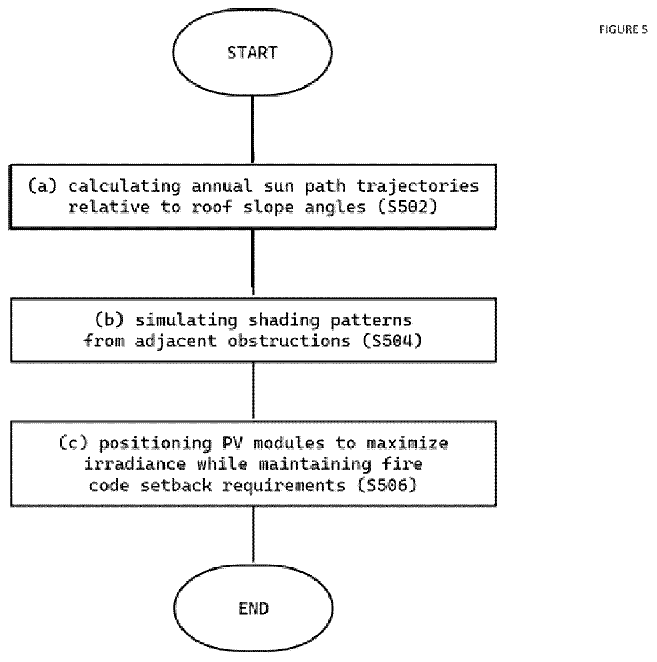

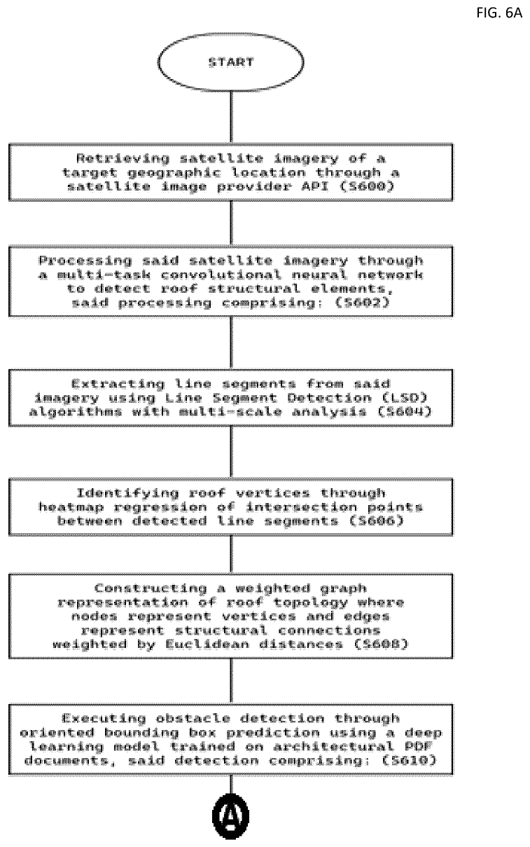

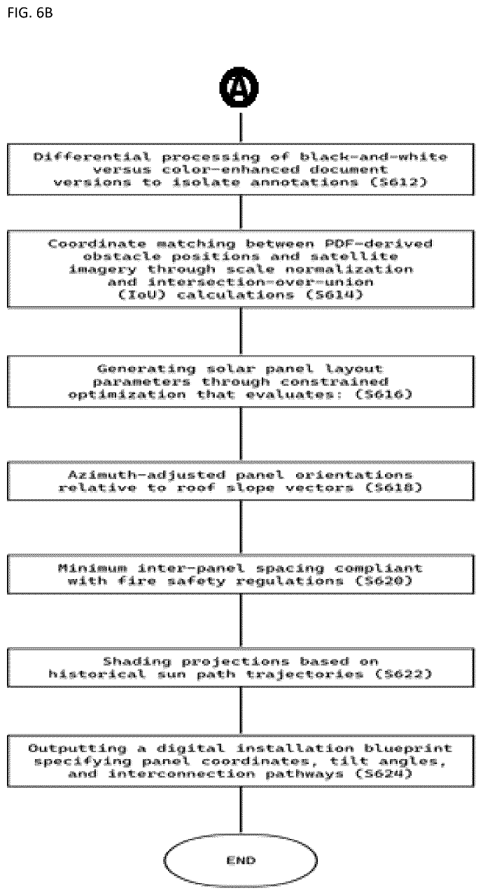

FIG. 5 illustrates the process for optimizing solar panel layout, which includes steps such as calculating annual sun path trajectories relative to roof slope angles, simulating shading patterns from adjacent obstructions, and positioning PV modules to maximize irradiance while maintaining fire code setback requirements. The process involves calculating annual sun path trajectories in relation to roof slope angles. This calculation offers valuable insight into how sunlight interacts with the roof surface over the course of a year. By determining these trajectories, the orientation and placement of solar panels can be optimized to maximize sunlight exposure, thereby enhancing energy capture efficiency.

The process involves simulating shading patterns caused by nearby obstructions. This simulation analyzes how these obstructions cast shadows over the roof area at various times of the day and throughout the year. This step is essential for optimizing photovoltaic (PV) module placement to maximize solar exposure while avoiding efficiency loss due to shading.

In the referenced step, photovoltaic (PV) modules are strategically positioned to ensure maximum exposure to sunlight, thus optimizing their energy output. This positioning also adheres to fire code setback requirements, ensuring safety regulations are met by maintaining adequate spacing between panels and potential fire hazards.

The retrieval of satellite imagery for a specific geographic location is conducted through an API provided by a satellite image service, indicated by S600. This process facilitates access to up-to-date and detailed images necessary for further analysis and processing in the overall methodology.

The method involves processing the satellite imagery using a multi-task convolutional neural network to identify roof structural elements. This processing step comprises extracting line segments from the imagery through the application of Line Segment Detection (LSD) algorithms with multi-scale analysis. The method further includes identifying roof vertices by employing heatmap regression at the intersection points between the detected line segments. Additionally, it involves constructing a weighted graph representation of the roof topology, where nodes embody vertices and edges signify structural connections weighted by Euclidean distances.

The method involves identifying roof vertices by employing heatmap regression to locate intersection points among detected line segments. This process is part of a larger scheme to accurately map the roof's structural layout. By analyzing these intersection points, the system constructs a detailed representation of the roof geometry, essential for subsequent analyses and processing steps.

In one aspect of the method, a weighted graph representation of roof topology is constructed, wherein nodes represent vertices identified through intersection points of detected line segments. The edges connecting these nodes correspond to structural connections, and each edge is weighted by the Euclidean distances between the respective vertices. This representation aids in accurately modeling the structure and layout of the roof based on the spatial relationships of its constituent elements.

The method involves executing obstacle detection through the prediction of oriented bounding boxes by utilizing a deep learning model trained on architectural PDF documents. This detection process includes differential processing of both black-and-white and color-enhanced versions of these documents to isolate annotations. Subsequently, coordinate matching is conducted between positions derived from the PDFs and satellite imagery, using scale normalization and intersection-over-union (IoU) calculations to ensure accuracy.

The step labeled “S612” involves differential processing, where both black-and-white and color-enhanced versions of a document are analyzed to isolate annotations. This process helps distinguish relevant details by comparing the two versions, revealing differences that indicate specific annotations or features within the document, thereby facilitating further analysis.

The method involves aligning obstacle positions derived from architectural PDF documents with satellite imagery. It achieves this by normalizing the scale of the images and calculating the intersection-over-union (IoU) to measure the accuracy of the match between the detected obstacles in both sources. This ensures precise correspondence for further processing.

In the disclosed method, the azimuth-adjusted panel orientations are calculated relative to roof slope vectors. This involves determining optimal alignment for solar panels to maximize efficiency based on the angles and direction of roof slopes. This computation takes into account the sun's position throughout the year to ensure that the panels receive maximum sunlight exposure. By adjusting the panel orientation in relation to the azimuth angle, the method optimizes solar energy capture while maintaining compliance with installation standards and constraints.

In one aspect, the method ensures that the solar panel layout complies with regulatory standards by determining the minimum required spacing between panels. This spacing is vital for upholding compliance with fire prevention guidelines. The constraints account for necessary setbacks and gaps, thereby encouraging secure installation practices on rooftops.

Referring to reference label S622, the method involves generating shading projections by analyzing historical sun path trajectories. This aspect applies these trajectories to evaluate how shadows are cast on prospective solar panel placements, ensuring optimal positioning to maximize sunlight exposure and efficiency throughout the year.

In the described method, the final stage involves generating a detailed installation blueprint. This blueprint meticulously specifies the coordinates for each solar panel on the roof, including their respective tilt angles. Additionally, it outlines the interconnection pathways needed for optimal energy flow and system functionality.

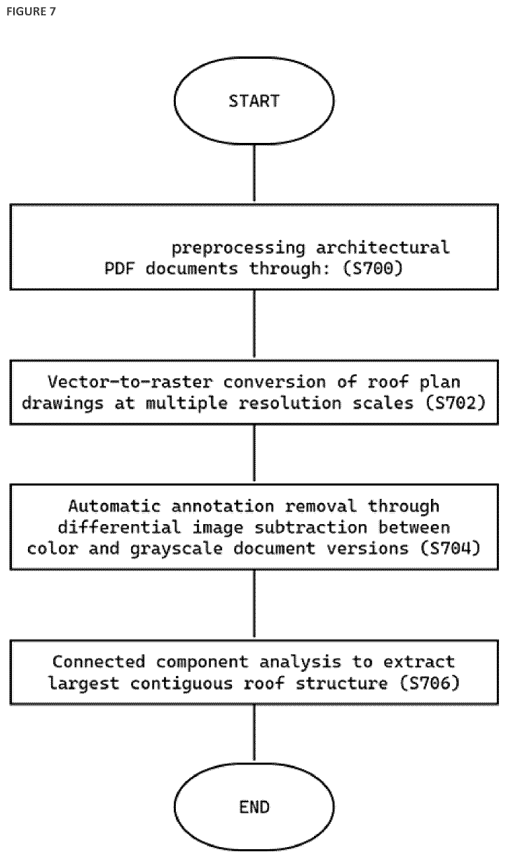

FIG. 7 illustrates the following references: a flowchart outlining the steps for automated roof plan processing and extraction, including preprocessing architectural PDF documents, vector-to-raster conversion of roof plans at multiple resolutions, automatic annotation removal through differential image subtraction, and connected component analysis to extract the largest contiguous roof structure.

In the described method, the step of vector-to-raster conversion involves transforming architectural roof plan drawings from their original vector format into raster images at various resolution scales. This conversion facilitates further image processing tasks required for analyzing and extracting roof structure details effectively.

In one aspect, the method involves automatic annotation removal by employing differential image subtraction between color and grayscale versions of a document. By comparing these two versions, the method identifies and isolates annotations within architectural PDF documents, allowing for cleaner data processing in subsequent steps. This technique enhances the accuracy of structural analysis, facilitating more precise extraction and interpretation of roof plans.

Connected component analysis is executed to identify and extract the largest contiguous roof structure from architectural documents. This process ensures that the primary roof section is isolated for further examination and processing. By leveraging computational techniques, the method effectively distinguishes the dominant roof area from supplementary elements, which facilitates accurate architectural analysis and subsequent planning or construction tasks.

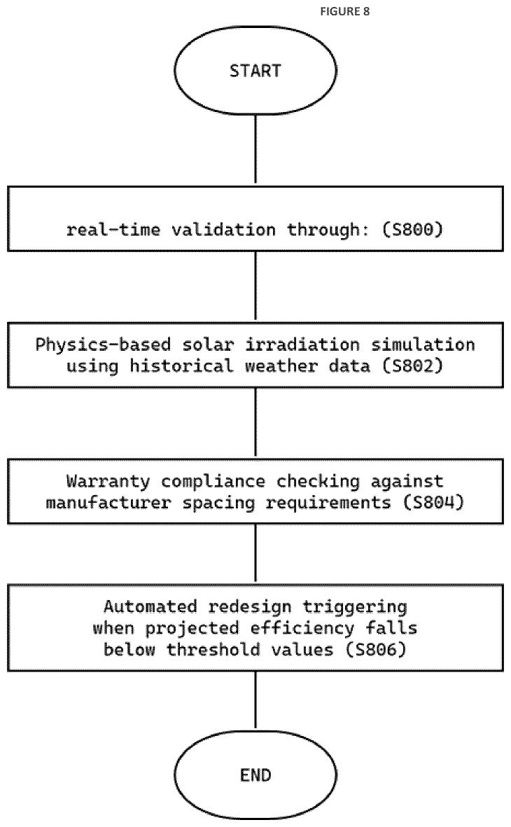

FIG. 8 illustrates a flowchart depicting a method for real-time validation, solar irradiation simulation, warranty compliance checking, and automated redesign triggering.

The method comprises real-time validation processes, which include physics-based solar irradiation simulation using historical weather data to enhance accuracy. Additionally, the method involves checking for warranty compliance by adhering to manufacturer-defined spacing requirements. If the projected efficiency falls below certain threshold values, an automated redesign is triggered to ensure optimal performance and compliance.

One implementation provides for real-time validation by implementing a physics-based solar irradiation simulation, wherein historical weather data is utilized to model and predict solar exposure. This simulation ensures an accurate assessment of irradiation levels on solar panels located at various roof positions, taking into account variations in sunlight intensity throughout the year. By leveraging comprehensive weather datasets, this process allows for precise analysis of potential energy generation, thereby supporting optimization and efficiency in solar panel installations.

The described method includes a step focused on ensuring that solar panel installations adhere to the spacing requirements specified by manufacturers. This process, known as warranty compliance checking, involves verifying that the design and placement of the panels meet these predefined standards. By doing so, it helps ensure that the installation not only functions efficiently but also maintains the validity of the manufacturer's warranty, thus protecting the investment and integrity of the solar power system.

The method involves automatically initiating a redesign process when the predicted efficiency of the system falls below specified threshold values. This ensures that any decrease in performance is promptly addressed by adapting the design to meet desired standards.

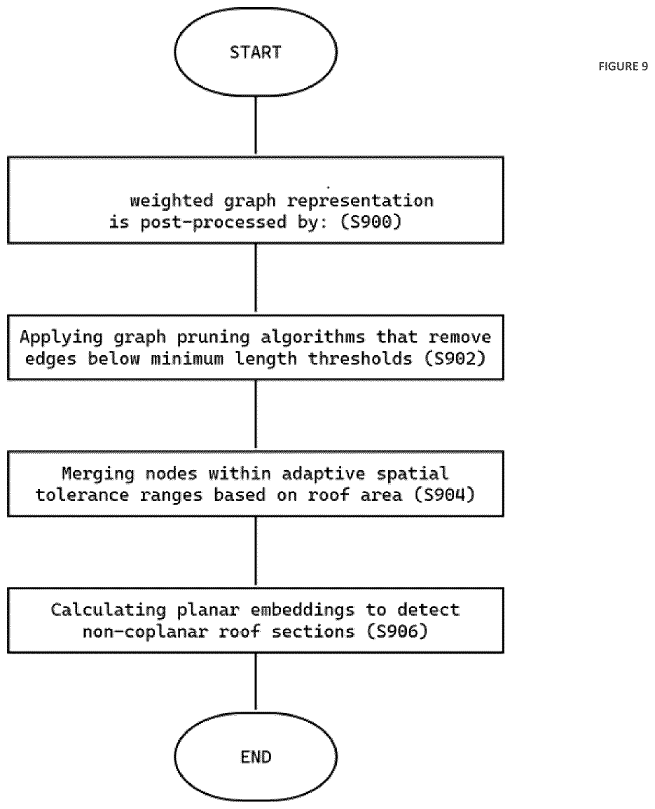

FIG. 9 illustrates the following references in detail:

S900: The method involves post-processing a weighted graph representation.

S902: This includes applying graph pruning algorithms to remove edges below minimum length thresholds.

S904: It also involves merging nodes within adaptive spatial tolerance ranges based on roof area.

S906: Finally, calculating planar embeddings to detect non-coplanar roof sections is performed.

The flowchart provides a visual guide through the steps necessary for processing a weighted graph in roof plan extraction.

The method involves post-processing the weighted graph representation of a roof plan extracted from imagery. Initially, graph pruning algorithms are applied to eliminate edges that do not meet minimum length criteria. Subsequently, nodes within the graph are merged if they fall within adaptive spatial tolerance ranges, which are determined based on the overall roof area. Finally, planar embeddings are calculated to identify sections of the roof that are not coplanar.

The method involves merging nodes within the weighted graph representation by applying adaptive spatial tolerance ranges determined by the roof area. This process enables the combination of nodes that are spatially proximate, facilitating a more cohesive and streamlined analysis of the roof structure.

The reference label “S906” designates the step of calculating planar embeddings to identify non-coplanar sections of a roof. This involves processing the graph representation of the roof to detect variations in the planarity of the surface, thereby identifying different geometric planes within the roof structure. This step is key in understanding the full architectural complexity of the roof and ensuring an accurate structural analysis.

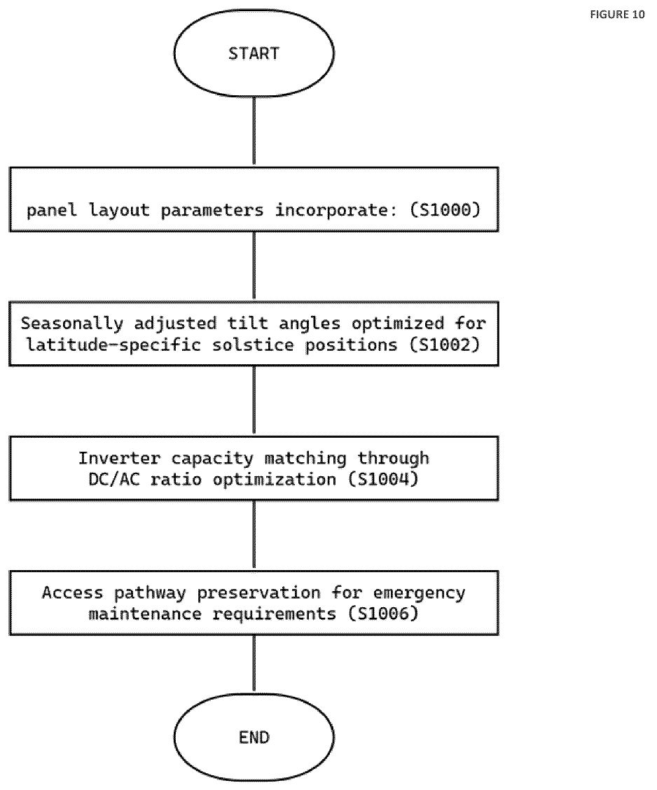

FIG. 10 illustrates the solar panel layout parameters, incorporating seasonally adjusted tilt angles optimized for latitude-specific solstice positions, inverter capacity matching through DC/AC ratio optimization, and access pathway preservation for emergency maintenance requirements.

The component “seasonally adjusted tilt angles optimized for latitude-specific solstice positions” (S1002) involves configuring solar panel tilt angles to maximize solar energy capture. This optimization takes into account latitude-specific variations in solar exposure during solstice periods. By adjusting the tilt angles seasonally, the method ensures that the panels are positioned to receive optimal sunlight, enhancing energy efficiency and performance year-round.

The method describes “inverter capacity matching through DC/AC ratio optimization” as an essential step in configuring solar panel layout parameters. This process involves adjusting the DC/AC ratio to ensure that the inverter's capacity is efficiently utilized. By optimizing this ratio, the system ensures maximum power conversion efficiency, improving the overall performance of the solar panel installation.

The process integrates provisions for preserving access pathways for emergency maintenance, ensuring that clear, unobstructed routes remain available on the roof. This arrangement is fundamental for enabling maintenance personnel to access the site quickly and address any potential issues with the solar panel system while adhering to relevant regulatory standards.

In some embodiments of one implementation, a line detection method is employed to identify line segments within an image captured from a document. The method comprises the use of either a Line Segment Detection (LSD) technique or a Hough Transform approach. In embodiments that utilize the LSD technique, the image is first preprocessed to enhance contrast and reduce noise prior to analysis. Subsequently, the LSD algorithm processes the image by computing gradients and examining the continuity of edge pixels to extract linear structures. This process enables the extraction of fine line segments that represent subtle features within the document. The extracted line segments are then filtered on the basis of criteria such as length and angular consistency to yield a refined set of candidate lines.

In embodiments employing the Hough Transform approach, the image is similarly preprocessed to optimize the detection of prominent edges. The Hough Transform is applied to the image, where points are mapped into a parameter space defined in accordance with the line equation. Accumulation of votes within this parameter space indicates the existence of straight lines. The method identifies peaks in the accumulator array corresponding to significant linear features, thus detecting line segments even when noise or partial occlusions are present.

In certain embodiments, the selection between the LSD technique and the Hough Transform approach is determined based on specific imaging conditions, available computational resources, or the scale of the features present in the image. After detection by either method, the extracted line segments are used in subsequent processing steps such as constructing a graph representation. In this graph, each detected line segment functions as a vertex while distances measured between segments define the edges, as previously described. The graph is then analyzed to identify the largest connected component corresponding to a roof plan, and additional processing, such as the removal of lines that do not correspond to roof structural elements, is performed to extract a roof layout.

In one embodiment, the method involves repeating the extraction procedure for both black-and-white and colored versions of a document. The document is first processed to generate two distinct representations, one in black-and-white and one in a color-enhanced format. Thereafter, an extraction algorithm is separately applied to each representation to isolate relevant features such as text annotations, line segments, and structural details indicative of the roof plan. For the black-and-white version, the extraction process involves applying thresholding and edge detection algorithms optimized for strong contrast images to delineate structural boundaries and eliminate extraneous markups. In parallel, when processing the color-enhanced version of the document, the extraction process incorporates color-specific information and leverages algorithms tuned to retain subtle variations in hue and saturation that correspond to critical annotations otherwise lost in monochromatic conversion. Following these separate extraction processes, differential processing is employed to compare and reconcile the outputs from both versions. This reconciliation step facilitates the identification and removal of spurious annotations and background artifacts while concurrently enhancing the extraction of key structural features. The extracted features from the two representations are then fused into a single integrated dataset that reliably represents the roof plan. The process further includes normalization steps that adjust for variations in scale or alignment between the two versions prior to applying subsequent operations such as constructing a graph in which each extracted line segment forms a vertex. By repeating the extraction procedure for both the black-and-white and the colored versions of the document, the method robustly captures a more comprehensive set of roof plan details, thereby enhancing the accuracy of downstream processes, including detection of roof vertices, segmentation of roof facets, and ultimately, the generation of a dimensioned roof diagram for further analysis and optimization steps.

In one embodiment, the method further comprises pre-training an AI segmentation model on an open-source dataset related to satellite-based roof contour mapping. A large collection of satellite imagery, which includes annotated roof contour data, is utilized for initial model training. The segmentation model, based on architectures such as U-Net or other fully convolutional networks, is pre-trained to perform semantic segmentation of roof structures, thereby learning to delineate roof boundaries and structural elements from the open-source dataset. The pre-training process involves augmenting the dataset with techniques such as rotation, scaling, and translation to bolster the model's robustness and generalization under various conditions encountered in satellite images. The weights obtained from this pre-training phase serve as an initialization for further fine-tuning on rooftop image datasets, including photographs, aerial imagery, and satellite imagery with associated annotated geometric measurements, as described in S300 and S302.

In one embodiment, an AI model is trained to recognize obstacles as oriented objects. The AI model is configured to analyze image data derived from architectural documents and satellite imagery to detect structural obstacles and other relevant elements. To enable this recognition, the model comprises a multi-task architecture that simultaneously predicts lines, points, and segmentation fields. In one implementation, convolutional neural network modules process the input images in parallel channels dedicated to each prediction task. The line prediction component generates a probabilistic map of linear features that correspond to the boundaries of initialized obstacles and to pertinent structural details. Concurrently, the point prediction component identifies salient keypoints, such as corners and intersection points, which serve as anchors for defining obstacle geometry. Additionally, the segmentation field prediction component produces dense pixel-wise masks that delineate the specific areas occupied by obstacles. These segmentation fields allow the model to distinguish obstacles from other non-relevant image features by capturing information related to shape and texture. The integration of these predictive tasks within a unified architecture yields a comprehensive depiction of obstacles, with each detected obstacle represented as an oriented object accompanied by geometric parameters including orientation and spatial extent. Training is accomplished by employing a composite loss function that simultaneously addresses errors in line prediction, keypoint regression, and segmentation accuracy. This joint optimization fosters better learning of shared features and contributes to the overall detection performance. During the training phase, data augmentation techniques—such as random rotations, translations, and scaling—are applied to ensure the model remains robust with respect to variations in obstacle orientation and image perspective. The resulting system is capable of reliably detecting and encoding structural obstacles as oriented objects, thereby supporting subsequent processing steps such as coordinate matching, graph-based roof plan extraction, and optimization of solar panel layout.

In one embodiment, the method further comprises post-processing steps that verify that each candidate line in the predicted roof layout is associated with a corresponding roof vertex. In these embodiments, after the initial roof layout is generated by processing the rooftop image via a trained AI model, candidate lines identified as potential roof structural elements undergo a verification process. This process involves determining the endpoints of each candidate line and comparing the spatial positions of these endpoints with the positions of detected roof vertices. For each candidate line, the method calculates a distance metric, such as the Euclidean distance, between each endpoint and its nearest roof vertex. A candidate line is confirmed to correspond to a roof vertex when the calculated distance for both endpoints falls within a predetermined spatial tolerance threshold. Candidate lines that fail to satisfy this matching criterion for one or more endpoints are excluded from the predicted roof layout.

In certain embodiments, the segmentation model is designed to improve its accuracy in predicting roof layouts by adopting an iterative refinement process that incorporates predictions from previous iterations. For example, an initial segmentation of the roof structure is generated from the input image through convolutional processing and feature extraction techniques. This initial prediction is then fed back into the segmentation model as an additional input along with the original image data for a subsequent iteration. During the next iteration, the model utilizes the prior prediction as contextual information, allowing it to re-assess segmentation boundaries and rectify any misclassifications or inaccuracies identified during the first pass. The process can be repeated several times until acceptable convergence is reached, at which point the roof layout prediction stabilizes or attains a predetermined level of accuracy. In some embodiments, the iterative refinement process includes the use of adaptive weighting factors or confidence metrics that prioritize improvements in regions with reduced initial accuracy. The segmentation model incorporates recurrent neural network elements or feedback loops that facilitate the integration of sequential predictions so that error information and spatial context from earlier iterations are leveraged to enhance feature representation in later iterations. This feedback mechanism enables the model to progressively eliminate noise, refine structural boundaries, and better accommodate variations in roof image characteristics such as scale, lighting, and occlusion. By iteratively updating its predictions, the model produces a more robust and precise roof layout that is effectively utilized in subsequent processing steps, including matching with corresponding satellite imagery and further analysis of roof structural elements.

In one embodiment, aerial or satellite imagery is obtained using sensor arrays designed to capture multi-spectral data that include visible wavelengths as well as infrared bands. The multi-spectral data undergo processing to distinguish roofing materials from the surrounding terrain by analyzing the corresponding infrared reflectance values. A trained convolutional neural network processes each spectral channel and extracts key features indicative of roofing materials. Infrared reflectance values are normalized and compared against predetermined thresholds corresponding to the reflective properties of common roofing materials such as asphalt shingles, metal, or tile. The identification module isolates roof regions by detecting variations in infrared reflectance that differ markedly from those observed in vegetative areas, soil, or water bodies.

This process is further enhanced by a fusion algorithm that integrates the infrared data with additional spectral bands to generate a composite image that accentuates roof structures while suppressing non-roof features. The fused imagery is subsequently subjected to additional image processing steps including edge detection, line segment extraction, and graph-based roof plan generation as previously described. In another embodiment, dynamic threshold adjustment is incorporated to account for seasonal variations and changing lighting conditions that affect infrared reflectance, thereby calibrating the system using historical multi-spectral data trends. This calibration yields superior differentiation of roofing materials from the background and reduces the rate of false detections.

By leveraging multi-spectral data, with the infrared band providing an additional discriminative parameter, the system achieves robust detection of roof structures. This enables accurate extraction of roof layouts and facilitates downstream analyses such as annotation of rooftop elements and optimization of solar panel placement.

In one embodiment, the method includes calculating pitch angles using a triangulation algorithm that maps parallax differences between overlapping aerial images. In this embodiment, overlapping aerial images are received from one or more aerial imaging systems configured to capture images from different vantage points. Corresponding features in each image are identified using established image processing techniques such as edge detection, corner detection, and line segment detection; these techniques incorporate elements of the previously described S102 and S604 for detecting line segments and S606 for identifying roof vertices. Once the corresponding features are identified, parallax differences between the overlapping images are computed. These differences are then mapped using a triangulation algorithm that leverages the known camera parameters, such as focal length, sensor size, and altitude, to determine the relative displacement of identical features across images. The triangulation algorithm computes the pitch angles by considering the displacement vectors derived from the parallax differences, thereby extracting fine-grained angle measurements that correspond to the roof's inclination. This process is augmented by employing iterative outlier rejection methods, such as a RANSAC-based routine, to ensure robustness against erroneous matches and to refine the computed pitch angles. The calculated pitch angles are integrated with additional roof structure extraction processes, such as those described in generating a dimensioned roof diagram (S306), to further enhance the overall accuracy of the roof model. In embodiments where the roof layout is processed from multiple sources, the determined pitch angles help reconcile discrepancies in roof structures by providing a three-dimensional reference that complements other measurements such as planar embeddings (S906) and geometric measurements from annotated datasets (S300-S302). The integration of these pitch angle measurements into further operations, such as matching with satellite imagery (S200-S208) and evaluation of solar panel layout parameters (S500, S616-S624), enhances the fidelity of the digital model of the roof as well as the efficiency of downstream processes like energy installation planning. The method continuously refines the pitch angle estimations as additional aerial images are processed, ensuring that temporal variations and environmental factors are accounted for in the final roof layout output and improving overall system reliability and performance.

In various embodiments, the method includes processing an image of a roof structure to determine intersection points by applying an AI model configured to analyze roof regions containing converging structural elements. The AI model receives rooftop imagery that incorporates line segments corresponding to the edges of roof facets and processes these segments to identify locations where multiple facets converge, thereby generating intersection points indicative of key structural junctions. In one embodiment, the model applies geometric and statistical analysis to the detected line segments so that the convergence of these segments—determined by evaluating angles, proximities, and the spatial density of their endpoints—facilitates the identification of salient intersection points on the roof structure.

The process further includes additional analyses wherein the AI model examines regions exhibiting penetrations in the facet area. These penetrations, which result from features such as skylights, vents, or other openings, are distinguished from regular facet intersections by comparing local deviations in the line segment patterns with expected geometric criteria. In some embodiments, dedicated sub-models or trained classifiers are employed to discern these penetrations from the general intersection points in order to accurately map structural irregularities or openings within the roof.

Additionally, the method contemplates evaluating slope variations within a single plane. In these cases, the AI model assesses local gradient changes across continuous roof regions through pixel intensity analyses, directional filters, or planar fitting techniques. When the slope varies within what is nominally a single plane, the model isolates these areas as indicators of either design variations or structural defects. The determination of slope variations is then correlated with the identified intersection points, thereby providing a comprehensive analysis of the roof's geometric features.

Further processing of architectural documents and satellite imagery is used to determine coordinates corresponding to roof obstructions. In one example, architectural PDF documents are converted from vector to raster formats at multiple resolution scales. Automatic annotation removal combined with connected component analysis identifies the largest contiguous roof structure, while differential processing between black-and-white and color-enhanced versions isolates annotations that indicate obstacles. The extracted obstruction coordinates are then aligned with satellite imagery data through scale normalization and intersection-over-union calculations.

The integrated roof layout, which merges the dimensioned roof diagram with precise slope angles and the identified obstruction coordinates, provides a comprehensive representation of the roof structure. This layout is used to optimize solar panel installation by enabling the calculation of annual sun path trajectories relative to roof slopes, simulating shading patterns from adjacent obstructions, and ensuring that panel positioning complies with fire code setback requirements. In repair planning scenarios, the layout facilitates the identification of areas requiring maintenance by detailing the spatial configuration and dimensions of roof elements along with the precise location of obstructions.

Finally, the method outputs a digital installation blueprint that specifies panel coordinates, tilt angles, and interconnection pathways (S624).

In another aspect, the method further comprises warranty compliance checking by comparing the spacing between photovoltaic modules against manufacturer spacing requirements. In this context, the method retrieves design specifications and mandated minimum or maximum inter-panel spacing values from a database of manufacturer guidelines. An automated process then measures or calculates the distances between installed modules as part of the layout analysis, verifying that each distance adheres to the prescribed tolerances. If any noncompliance is detected, the method flags these deviations for review or further corrective action, thereby ensuring that the installation remains within the warranty conditions specified by the manufacturer.

Moreover, the method further comprises an automated redesign triggering mechanism that activates when the projected efficiency of the photovoltaic system, as determined from the simulation outputs and real-time monitoring, falls below a predetermined threshold. In such circumstances, the system initiates an automated redesign process that reassesses the current layout and, through iterative simulation and optimization steps, generates an updated photovoltaic module configuration aimed at improving overall energy capture. This redesign process includes adjusting module orientation, repositioning modules to reduce shading, or modifying panel spacing, and is performed in accordance with pre-established performance criteria and safety standards. The seamless transition from simulation to redesign ensures that the system dynamically adapts to changing conditions, maintains optimal efficiency, and consistently meets both performance and warranty requirements.

Additionally, the detailed processing includes the preservation of access pathways to facilitate emergency maintenance. The method specifies particular zones within the roof layout that must remain unobstructed. During the panel placement optimization phase, the algorithm accounts for these spatial constraints by identifying and demarcating regions based on the detected roof plan and existing structural elements. Mathematical models simulate potential access routes, and panel layout designs are iteratively adjusted to ensure that designated emergency pathways retain sufficient clearance. This preservation is not only essential for safety compliance but also guarantees that maintenance personnel can safely access the installation for repairs or routine inspections.

In sum, method and system are provided for automated extraction of roof plans, determination of roof dimensions, and generation of solar panel layouts. One implementation processes roof images by identifying the largest component, detecting line segments using techniques such as LSD or the Hough Transform, and constructing a graph with vertices formed by these segments connected by distance-weighted edges. Refinement steps include filtering out non-structural lines, merging segments, thresholding, and removing redundancies to produce an accurate roof plan. A pre-trained AI segmentation model—with a potential multi-task architecture for predicting lines, points, and segmentation fields—is used to recognize roof contours and obstacles, including oriented objects, with an iterative process ensuring candidate lines correspond to roof vertices. Roof dimensions and pitch are determined using multiple labeled rooftop image datasets containing annotated geometric measurements; the AI model segments roof facets, calculates planar angles, and generates a dimensioned roof diagram, while multi-spectral data and triangulation algorithms distinguish roofing materials and calculate pitch angles. For solar panel layout generation, satellite imagery is retrieved and processed through a multi-task convolutional neural network to detect structural elements, resulting in the construction of a weighted graph representing roof topology. This graph is post-processed through pruning and node merging, and obstacle detection is enhanced by oriented bounding box prediction and differential image analysis from PDF documents. Finally, optimization routines compute solar panel parameters by evaluating azimuth-adjusted orientations, inter-panel spacing that complies with safety codes, and shading projections based on historical sun path data, with further real-time validation using physics-based solar irradiation simulations and warranty compliance checks. Overall, incorporating these parameters into the solar panel layout design enables a comprehensive approach that maximizes solar energy capture, optimizes power conversion efficiency, and ensures enduring operational safety and accessibility of the installation.

The system presents a comprehensive set of geospatial and schematic data for a roof structure, utilizing both reconstructed plans and original reference images to delineate architectural components. This analysis focuses on interpreting pairs of images that illustrate the roof's GPS coordinates, reconstructed planimetric features, vertex distributions, and linework definitions. Each image pair serves to clarify the spatial relationships and structural elements critical for accurate patent documentation, particularly in domains requiring precise geometric representations such as orthodontic aligner manufacturing or photographic printing technologies1.

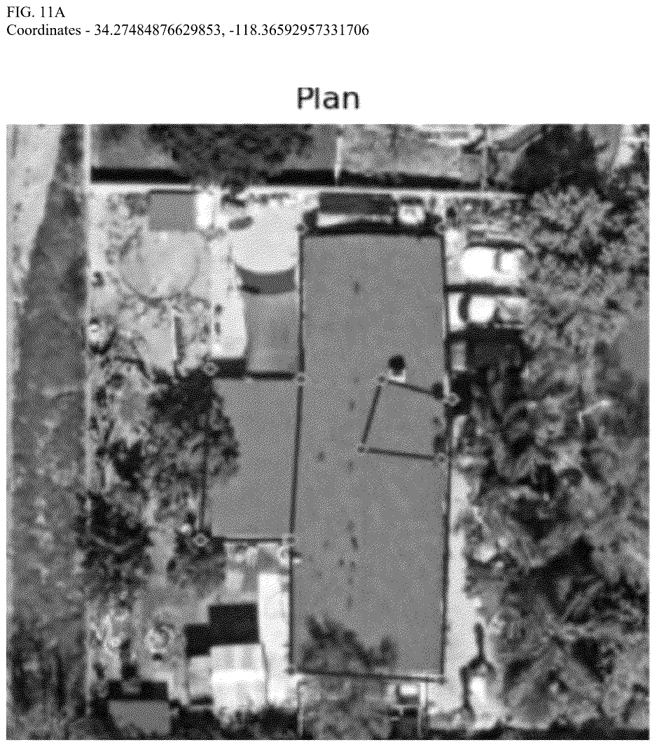

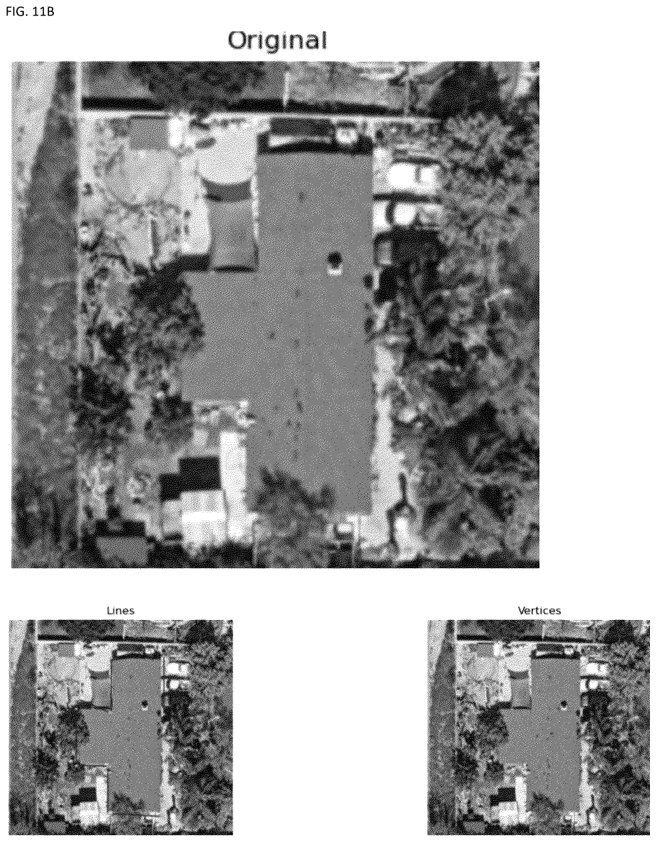

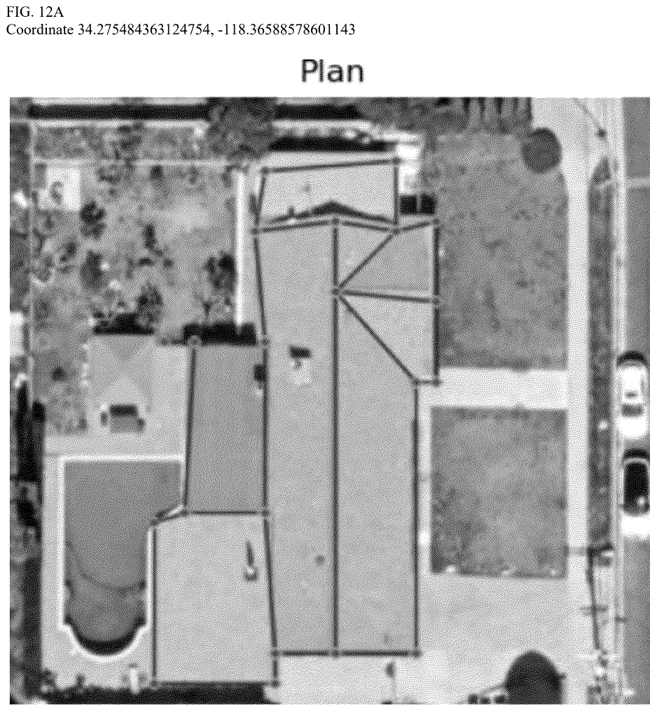

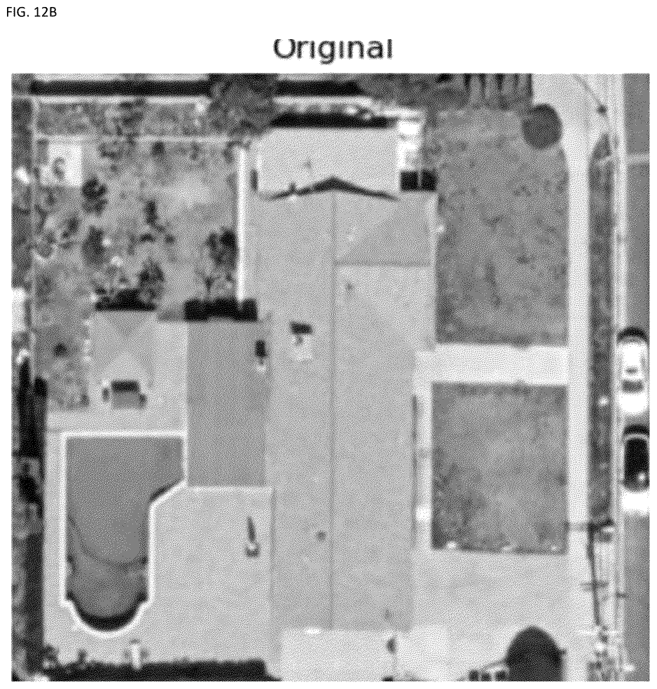

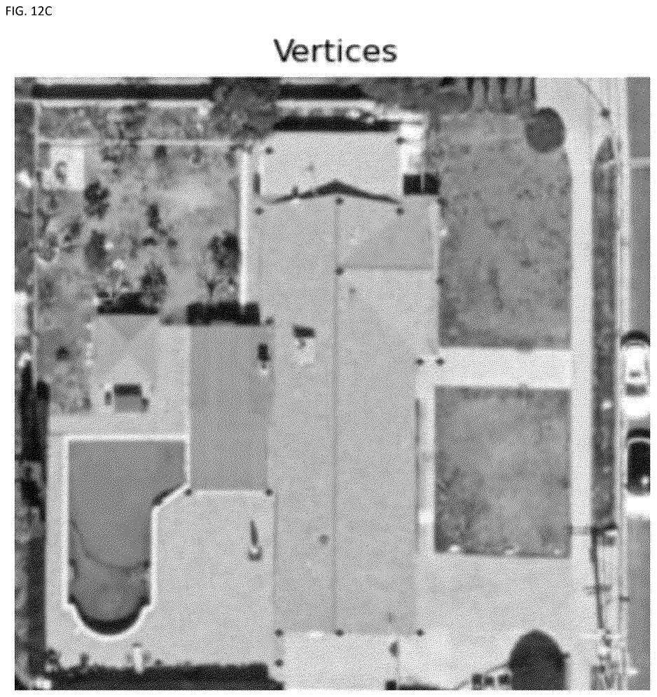

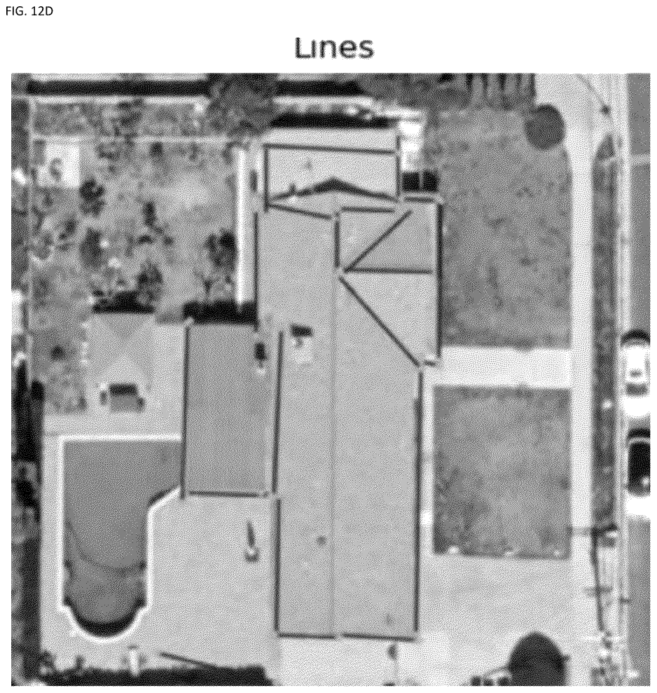

In the example of FIGS. 11A-11B and FIGS. 12A-12D, the structures are roofs above homes in Southern California in these examples. FIG. 11A and FIG. 12A show the analyzed roof plans, while FIG. 11B and FIG. 12B-12D show the original image, an image with vertex placements and their connecting line segments. Vertices are plotted at all roof intersection points, with coordinate pairs specifying connections of the lines forming the geometry of the roof plan.

1. A method to determine a roof plan from a document having an image of a roof, comprising:
detecting line segments in the image using a line detection method;
constructing a graph where each detected line segment comprises a graph vertex, distance measured between segments form the graph edges, and the largest connected component of the graph represents the roof plan; and
extracting a roof layout from the roof plan by filtering out lines that do not correspond to roof structural elements.

2. The method of claim 1, wherein the line detection method comprises either LSD method or Hough Transform method.

3. The method of claim 1, comprising merging the detected line segments, applying thresholding to the line segments, and removing line redundancies.

4. The method of claim 1, comprising repeating the extraction for black-and-white and colored versions of the document.

5. The method of claim 1, further comprising pre-training an AI segmentation model on an open-source dataset related to satellite-based roof contour mapping.

6. The method of claim 5, wherein the AI model is trained to recognize obstacles as oriented objects.

7. The method of claim 5, comprising wherein the AI model comprises a multi-task model architecture that predicts lines, points, and segmentation fields simultaneously.

8. The method of claim 1, further comprising post-processing steps to verify that each candidate line in the predicted roof layout can be matched with a corresponding roof vertex.

9. The method of claim 1, wherein the segmentation model is iteratively refined by incorporating predictions from previous iterations to improve accuracy in roof layout prediction.

10. The method of claim 1, comprising matching the extracted roof layout with a corresponding satellite image by:
extracting an address and scale are extracted from the document using large language models and text processing techniques;
retrieving a satellite image and applying a large vision model (SAM) to identify a candidate building;
determining an intersection over union (IoU) of the candidate building from the model and generating a roof layout;
if the IoU exceeds a threshold, the roof layout is added to the ground truth dataset.

11. A computer-implemented method to determine roof dimensions, comprising:
receiving a plurality of labeled rooftop image datasets, wherein each dataset includes images including photographs, aerial imagery, or satellite imagery of a roof structure and annotated geometric measurements of roof edges, slopes, and obstructions;
training an AI model using supervised machine learning to correlate pixel patterns in the imagery with the annotated geometric measurements, wherein the training optimizes a loss function evaluating accuracy of predicted roof edges, facet lengths, and slope angles;
processing an unlabeled rooftop image through the trained AI model to: detect perimeter boundaries of the roof structure, segment distinct roof facets, calculate planar angles between adjacent facets; and
generating a dimensioned roof diagram specifying linear measurements for each facet edge and angular measurements for intersecting planes.

12. The method of claim 11, wherein the aerial or satellite imagery includes multi-spectral data, comprising distinguishing roofing materials from surrounding terrain using infrared reflectance values.

13. The method of claim 11, comprising calculating pitch angles using a triangulation algorithm that maps parallax differences between overlapping aerial images.

14. The method of claim 11, comprising augmenting the training datasets with roof obstructions including trees, chimneys, vents, and satellite dishes.

15. The method of claim 11, comprising determining intersection points on the roof structure.

16. The method of claim 11, comprising generating a roof layout incorporating the dimensioned roof diagram, slope angles, and obstruction coordinates for use in solar panel installation or repair planning.

17. The method of claim 11, comprising optimizing solar panel layout by:
(a) calculating annual sun path trajectories relative to roof slope angles;
(b) simulating shading patterns from adjacent obstructions;
(c) positioning PV modules to maximize irradiance while maintaining fire code setback requirements.

18. A computer-implemented method for automated solar panel layout generation comprising:
retrieving satellite imagery of a target geographic location;
processing said satellite imagery through a multi-task convolutional neural network to detect roof structural elements, said processing comprising:
extracting line segments from said imagery using Line Segment Detection (LSD) with multi-scale analysis;
identifying roof vertices through heatmap regression of intersection points between detected line segments;
constructing a weighted graph representation of roof topology where nodes represent vertices and edges represent structural connections weighted by Euclidean distances;
executing obstacle detection through oriented bounding box prediction using a deep learning model trained on architectural documents, said detection comprising:
differential processing of black-and-white versus color-enhanced document versions to isolate annotations;
coordinate matching between obstacle positions and satellite imagery through scale normalization and intersection-over-union (IoU) calculations;
generating solar panel layout parameters through constrained optimization that evaluates:
azimuth-adjusted panel orientations relative to roof slope vectors;
minimum inter-panel spacing compliant with fire safety regulations; and
shading projections based on historical sun path trajectories;
outputting a digital installation blueprint specifying panel coordinates, tilt angles, and interconnection pathways.

19. The method of claim 18, further comprising preprocessing architectural PDF documents through:
vector-to-raster conversion of roof plan drawings at multiple resolution scales;
automatic annotation removal through differential image subtraction between color and grayscale document versions; and
connected component analysis to extract largest contiguous roof structure.

20. The method of claim 18, further comprising real-time validation through: physics-based solar irradiation simulation using historical weather data; warranty compliance checking against manufacturer spacing requirements; and automated redesign triggering when projected efficiency falls below threshold values.

21. The method of claim 18, wherein said weighted graph representation is post-processed by: applying graph pruning algorithms that remove edges below minimum length thresholds; merging nodes within adaptive spatial tolerance ranges based on roof area; and calculating planar embeddings to detect non-coplanar roof sections.

22. The method of claim 18, wherein said solar panel layout parameters incorporate: seasonally adjusted tilt angles optimized for latitude-specific solstice positions; and inverter capacity matching through DC/AC ratio optimization; and access pathway preservation for emergency maintenance requirements.
